(19) United States
(12) Patent Application Publication
(10) Pub. No.: US 2007/0123181 A1
(43) Pub. Date: May 31, 2007

(54) Antenna system for enabling diversity and MIMO

(75) Inventors: Giorgi Bit-Babik, Sunrise, FL (US); Antonio Faraone, Plantation, FL (US); Carlo DiNallo, Plantation, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/290,175

(22) Filed: Nov. 30, 2005

(51) Int. Cl. H04B 1/02; H04B 1/04; H04M 1/00

(52) U.S. Cl. 455/101; 455/103; 455/575.7

(57) ABSTRACT

An RF communication system (100) including a first antenna (110) having a first antenna element (112) and a second antenna element (114), and a second antenna (120) having a third antenna element (122) and a fourth antenna element (124). A first transmitter (150) can apply a first signal commonly to the first antenna and a second transmitter (152) can apply a second signal differentially to the first antenna. A third transmitter (154) can apply a third signal commonly to the second antenna and a fourth transmitter (156) can apply a fourth signal differentially to the second antenna. In another arrangement, a first transmitter (350) can apply a first signal commonly or differentially to the first antenna and a second transmitter (352) can apply a second signal commonly or differentially to the second antenna.

### BACKGROUND OF THE INVENTION

1. Field of the Invention

The present invention generally relates to antenna systems and, more particularly, to antenna systems for mobile devices.

2. Background of the Invention

Mobile communication devices such as mobile telephones and personal digital assistants (PDAs) typically communicate via RF signals transmitted in the upper MHz (e.g. 900 MHz) or lower GHz (e.g. 1.8 GHz) frequency ranges. In multi-path environments, such as urban areas, RF signals propagated at these frequencies are especially susceptible to reflection and scattering caused by interaction of the signals with buildings and other structures. In consequence, mobile communication devices often receive multiple instances of the same RF signal with each instance following a different propagation path. For example, a device may receive a first instance of an RF signal that is reflected off of a first building and a second instance of the same RF signal that is reflected off of a second building. Different instances of the RF signal typically are received at different times, depending on the propagation path of each instance. Accordingly, the different signal instances are oftentimes referred to as uncorrelated signals.

Two types of antenna systems that have been developed for use in multi-path environments are diversity antennas systems and multiple-input/multiple-output (MIMO) antenna systems. A diversity antenna system includes multiple antenna elements to receive or transmit an RF signal and processes the signal from the element receiving the highest quality signal. Depending on their orientation, different antenna elements may receive different uncorrelated instances of the RF signal. A MIMO antenna system also includes multiple antenna elements. In contrast to diversity antenna systems, MIMO antenna systems simultaneously process uncorrelated signals. Both diversity and MIMO antenna systems can increase system capacity and improve reliability in comparison to antenna systems which use a single antenna element.

### SUMMARY OF THE INVENTION

The present invention relates to an RF communication system. The RF communication system can include a first antenna having a first antenna element and at least a second antenna element, and a second antenna having a third antenna element and at least a fourth antenna element. The system also can include a first transmitter that applies a first outbound RF signal commonly to the first and second antenna elements, and a second transmitter that applies a second outbound RF signal differentially to the first and second antenna elements. In addition, the system can include a third transmitter that applies a third outbound RF signal commonly to the third and fourth antenna elements, and a fourth transmitter that applies a fourth outbound RF signal differentially to the third and fourth antenna elements.

The system further can include a printed circuit board. The printed circuit board can have a first edge portion and a second edge portion opposingly positioned with respect to the first edge portion. The first antenna element can be disposed proximate to the first edge portion and the second antenna element can be disposed proximate to the second edge portion. The printed circuit board also can have a third edge portion and a fourth edge portion opposingly positioned with respect to the third edge portion. The third antenna element can be disposed proximate to the third edge portion and the fourth antenna element can be disposed proximate to the fourth edge portion. An orientation of the first antenna can be perpendicular to an orientation of the second antenna.

The first transmitter and/or the second transmitter can be selectively operable in a transmit mode in which either of the first outbound RF signal and the second outbound RF signal that exhibits higher quality signal transmission characteristics in comparison to the other signal is exclusively transmitted from the first antenna. Similarly, the third transmitter and the fourth transmitter can be selectively operable in a transmit mode in which either of the third outbound RF signal and the fourth outbound RF signal that exhibits higher quality signal transmission characteristics in comparison to the other signal is exclusively transmitted from the second antenna.

The system also can include a first receiver that receives a first inbound RF signal commonly from the first and second antenna elements and a second receiver that receives a second inbound RF signal differentially from the first and second antenna elements. In addition, the system can include a third receiver that receives a third inbound RF signal commonly from the third and fourth antenna elements and a fourth receiver that receives a fourth inbound RF signal differentially from the third and fourth antenna elements.

The first receiver and/or the second receiver can be selectively operable in a receive mode in which either of the first inbound RF signal and the second inbound RF signal that exhibits higher quality signal reception characteristics in comparison to the other signal is exclusively received from the first antenna. Similarly, the third receiver and the fourth receiver can be selectively operable in a receive mode in which either of the third inbound RF signal and the fourth inbound RF signal that exhibits higher quality signal reception characteristics in comparison to the other signal is exclusively received from the second antenna.

The RF communication system also can include a first transmitter that applies a first outbound RF signal commonly to the first and second antenna elements in a first transmit mode, and applies the first outbound RF signal differentially to the first and second antenna elements in a second transmit mode. In addition, a second transmitter can be provided. The second transmitter can apply a second outbound RF signal commonly to the third and fourth antenna elements in a third transmit mode, and apply the second outbound RF signal differentially to the third and fourth antenna elements in a fourth transmit mode.

The RF communication system can be selectively operable in a plurality of system modes for transmitting RF signals. In a first system mode the first transmitter can operate in the first transmit mode and the second transmitter can operate in the third transmit mode. In a second system mode the first transmitter can operate in the first transmit mode and the second transmitter can operate in the fourth transmit mode. In a third system mode the first transmitter can operate in the second transmit mode and the second transmitter can operate in the third transmit mode. In a fourth system mode the first transmitter can operate in the second transmit mode and the second transmitter can operate in the fourth transmit mode.

The first transmitter can be selectively operable in the first transmit mode if the first outbound RF signal exhibits higher quality signal transmission characteristics in the first transmit mode in comparison to the second transmit mode, and the first transmitter can be selectively operable in the second transmit mode if the first outbound RF signal exhibits higher quality signal transmission characteristics in the second transmit mode in comparison to the first transmit mode. Likewise, the second transmitter can be selectively operable in the third transmit mode if the second outbound RF signal exhibits higher quality signal transmission characteristics in the third transmit mode in comparison to the fourth transmit mode, and the second transmitter can be selectively operable in the fourth transmit mode if the second outbound RF signal exhibits higher quality signal transmission characteristics in the fourth transmit mode in comparison to the third transmit mode.

The RF communication system also can include a first receiver and a second receiver. The first receiver can receive a first inbound RF signal commonly from the first and second antenna elements in a first receive mode, and can receive the first inbound RF signal differentially from the first and second antenna elements in a second receive mode. The second receiver can receive a second inbound RF signal commonly from the third and fourth antenna elements in a third receive mode, and can receive the second inbound RF signal differentially from the third and fourth antenna elements in a fourth receive mode.

The RF communication system can be selectively operable in a plurality of system modes for receiving inbound RF signals. In a first system mode the first receiver can operate in the first receive mode and the second receiver can operate in the third receive mode. In a second system mode the first receiver can operate in the first receive mode and the second receiver can operate in the fourth receive mode. In a third system mode the first receiver can operate in the second receive mode and the second receiver can operate in the third receive mode. In a fourth system mode the first receiver can operate in the second receive mode and the second receiver can operate in the fourth receive mode.

In addition, the first receiver can be selectively operable in the first receive mode if the first inbound RF signal exhibits higher quality signal receive characteristics in the first receive mode in comparison to the second receive mode, and the first receiver can be selectively operable in the second receive mode if the first inbound RF signal exhibits higher quality signal receive characteristics in the second receive mode in comparison to the first receive mode. Similarly, the second receiver can be selectively operable in the third receive mode if the second inbound RF signal exhibits higher quality signal receive characteristics in the third receive mode in comparison to the fourth receive mode, and the second receiver can be selectively operable in the fourth receive mode if the fourth inbound RF signal exhibits higher quality signal receive characteristics in the fourth receive mode in comparison to the third receive mode.

### BRIEF DESCRIPTION OF THE DRAWINGS

Preferred embodiments of the present invention will be described below in more detail, with reference to the accompanying drawings, in which:

FIG. 1 depicts an RF communication system useful for understanding the present invention.

FIG. 2 depicts another arrangement of the RF communication system.

FIG. 3 depicts yet another arrangement of the RF communication system.

FIGS. 4-7 depict examples of field patterns that can be generated by the RF communication system.

FIG. 8 depicts the RF communication system positioned proximate to the a user's head.

FIGS. 9-12 depict examples of field patterns that can be generated by the RF communication system when positioned as shown in FIG. 8.

FIG. 13 depicts the RF communication system positioned proximate to the a user's hand.

FIGS. 14-17 depict examples of field patterns that can be generated by the RF communication system when positioned as shown in FIG. 13.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to an RF communication system that can simultaneously transmit and receive multiple uncorrelated signals. Because the signals are uncorrelated, the signals can be used as distinct communication channels, thereby providing high system capacity over a given bandwidth. In addition, the antenna system can simultaneously operate both as a diversity antenna system and as a multiple-input/multiple-output (MIMO) antenna system, thereby providing improved system performance in multi-path environments in comparison to systems of the prior art.

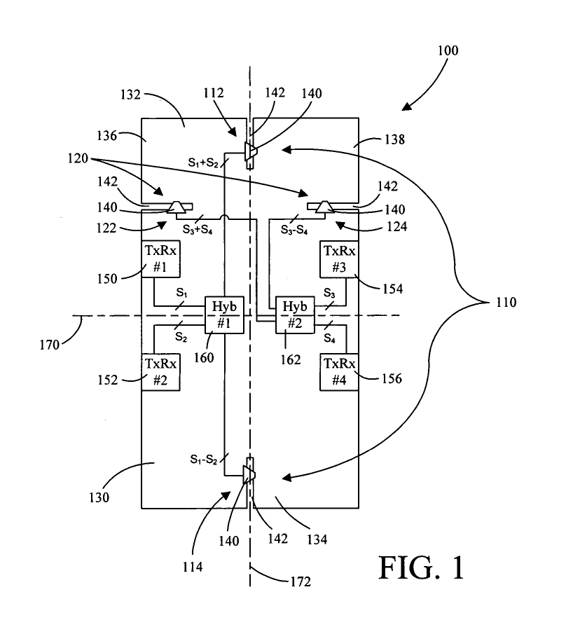

FIG. 1 depicts an RF communication system 100 that is useful for understanding the present invention. The RF communication system 100 can include a first antenna 110 and a second antenna 120. The first antenna 110 can include a first antenna element 112 and at least a second antenna element 114. Similarly, the second antenna 120 can include a third antenna element 122 and at least a fourth antenna element 124. An orientation of the first antenna 110 can be approximately perpendicular to an orientation of the second antenna 120. For instance, an alignment of the first antenna element 112 with respect to the second antenna element 114 can be perpendicular to an alignment of the third antenna element 122 with respect to the fourth antenna element 124.

The RF communication system 100 also can include a printed circuit board 130 on which components of the system 100, such as the antenna elements 112, 114, 122, 124, are disposed. The printed circuit board 130 can be, for example, a printed circuit board for a mobile communication device, such as a handheld communication device.

The printed circuit board 130 can include a first edge portion 132 and a second edge portion 134. The second edge portion 134 can be opposingly positioned with respect to the first edge portion 132. The first antenna element 112 can be disposed proximate to the first edge portion 132 and the second antenna element 114 can be disposed proximate to the second edge portion 134. The printed circuit board 130 further can include a third edge portion 136 and a fourth edge portion 138. The fourth edge portion 138 can be opposingly positioned with respect to the third edge portion 136. The third antenna element 122 can be disposed proximate to the third edge portion 136 and the fourth antenna element 124 can be disposed proximate to the fourth edge portion 138.

In one arrangement, the antenna elements 112, 114, 122, 124 each can include an antenna feed 140 disposed proximate to a slot 142 defined within the printed circuit board 130, thereby forming slot antenna elements. In another arrangement, the antenna elements 112, 114, 122, 124 each can include a patch antenna element or planar inverted-F antenna (PIFA) element realized proximate to the printed circuit board 130. In yet another arrangement, the antenna elements 112, 114, 122, 124 each can include a monopole or folded monopole antenna element disposed approximately orthogonal to the respective edge portions 132, 134, 136, 138. Slot antenna elements, patch antenna elements, PIFA antenna elements, and monopole and folded monopole antenna elements are known to the skilled artisan. Other antenna elements also are known to the skilled artisan and are within the scope of the present invention.

Referring again to FIG. 1, the RF communication system 100 also can include a first transceiver 150, a second transceiver 152, a third transceiver 154 and a fourth transceiver 156. The first transceiver 150 can operate as a first transmitter and as a first receiver, the second transceiver 152 can operate as a second transmitter and as a second receiver, the third transceiver 154 can operate as a third transmitter and as a third receiver, and the fourth transceiver 156 can operate as a fourth transmitter and as a fourth receiver.

A first hybrid circuit 160 can be communicatively linked between the first and second transceivers 150, 152 and the first and second antenna elements 112, 114. Similarly, a second hybrid 162 can be communicatively linked between the third and fourth transceivers 154, 156 and the third and fourth antenna elements 122, 124. The hybrids 160, 162 can be multi-port devices which receive input signals and generate correlating output signals that are either in-phase with respect to the input signals and/or out-of-phase with respect to the input signals. Hybrids are reciprocal components that are known to the skilled artisan. Other reciprocal and non-reciprocal components which may perform the same functions as the hybrids 160, 162 also are known to those skilled in the art, and are within the scope of the present invention.

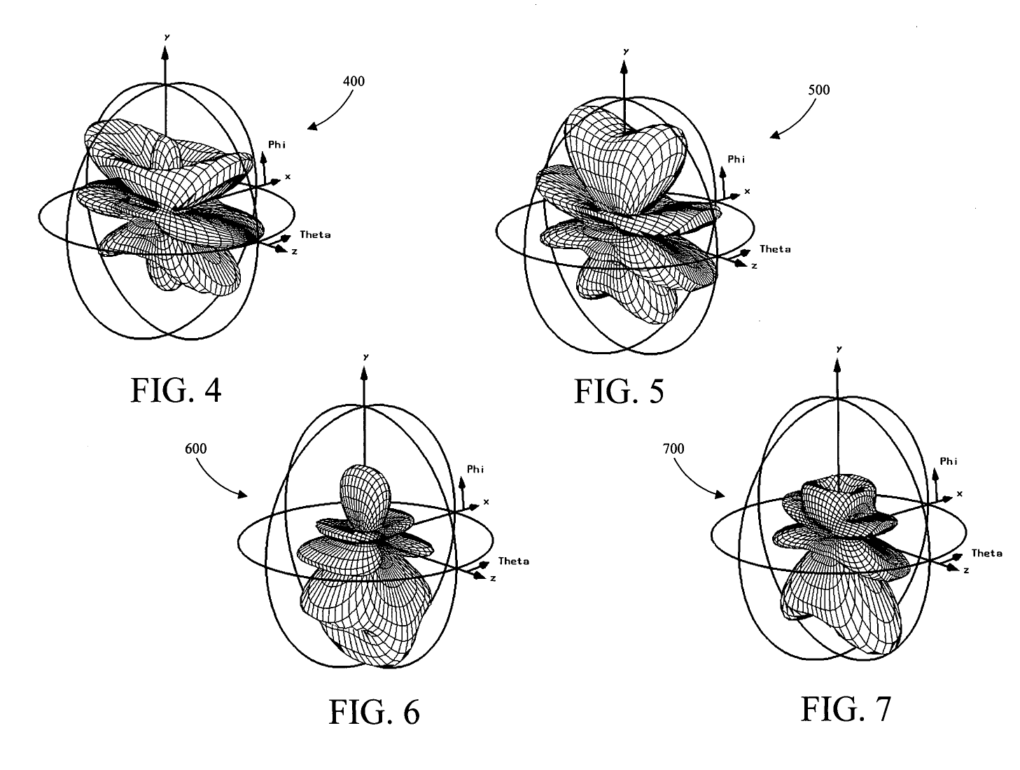

In operation, the first hybrid 160 can receive a first outbound RF signal—hereinafter “first signal S₁”—from the first transceiver 150 and propagate the first signal S₁ commonly, or in-phase, to the first and second antenna elements 112, 114. An example of the field pattern 400 that can be produced by commonly applying the first signal S₁ to the first and second antenna elements 112, 114 is shown in FIG. 4. The first hybrid 160 also can receive a second outbound RF signal—hereinafter “second signal S₂”—from the second transceiver 152 and propagate the second signal S₂ differentially, or out-of-phase, to the first and second antenna elements 112, 114. An example of the field pattern 500 that can be produced by differentially applying the second signal S₂ to the first and second antenna elements 112, 114 is shown in FIG. 5.

Notably, the degree of correlation between the radiated electromagnetic fields associated with the commonly applied first signal S₁ and the radiated electromagnetic fields associated with the differentially applied second signal S₂ can be very low. For example, the degree of correlation between the first and second signals S₁, S₂ can be computed by the following equation:

$${ρ}_{12} \approx \frac{{\vert E \{ {E}_{1} ( θ , ϕ ) \cdot {E}_{2}^{*} ( θ , ϕ ) \} \vert}^{2}}{E \{ {\vert {E}_{1} ( θ , ϕ ) \vert}^{2} \} E \{ {\vert {E}_{2} ( θ , ϕ ) \vert}^{2} \}} \qquad ( 1 )$$

where E{·} is the expected value operator and Eᵢ(θ,φ) (i=1, 2) is the radiated electric field pattern relative to the i-th transmit or receive mode. Applying this equation to the example RF communication system 100 of FIG. 1, assuming a uniform angular distribution for the multi-path components, an expected correlation coefficient of 7.7e−4 (−31 dB) can be computed. Such a level of correlation between the first and second signals S₁, S₂ when the first and second signals are simultaneously transmitted is, for the most part, negligible. Accordingly, the level of interference to either of the signals S₁, S₂ caused by their simultaneous transmission is negligible.

The second hybrid 162 can receive a third outbound RF signal—hereinafter “third signal S₃”—from the third transceiver 154 and propagate the third signal S₃ commonly to the third and fourth antenna elements 122, 124. An example of the field pattern 600 that can be produced by commonly applying the third signal S₃ to the third and fourth antenna elements 122, 124 is shown in FIG. 6. The second hybrid 162 also can receive a fourth outbound RF signal—hereinafter “fourth signal S₄”—from the fourth transceiver 156 and propagate the fourth signal S₄ differentially to the third and fourth antenna elements 122, 124. An example of the field pattern 700 that can be produced by differentially applying the fourth signal S₄ to the third and fourth antenna elements 122, 124 is shown in FIG. 7.

The field patterns 600, 700 produced by excitation of the third and fourth antenna elements 122, 124 can be non-symmetrical, as shown, by offsetting the third and fourth antenna elements 122, 124 with respect to a centerline 170 of the printed circuit board 130. The invention is not limited in this regard, however. For example, the third and fourth antenna elements 122, 124 can be aligned on the centerline 170 to produce a symmetrical field pattern. Moreover, although the first and second antenna elements 112, 114 can be aligned with a centerline 172 of the printed circuit board 130, as shown, the first and second antenna elements 112, 114 also can be offset from the centerline 172 to produce a non-symmetrical field pattern.

By way of example, equation (1) can be applied to the RF communication system 100 of FIG. 1 to compute an expected correlation coefficient of 5.3e−9 (−83 dB) for the third and fourth signals S₃, S₄. Thus, the third and fourth signals S₃, S₄ can be simultaneously transmitted from the second antenna 120 with negligible interference between the signals S₃, S₄.

In addition to providing a very small degree of correlation between signals applied commonly and differentially to a particular antenna, the present invention also provides for a very small degree of correlation between the signals S₁, S₂ applied to the first antenna 110 and the signals S₃, S₄ applied to the second antenna 120. For example, applying equation (1) to the RF communication system 100 of FIG. 1, assuming a uniform angular distribution for the multi-path components, the following table of correlation coefficients can be predicted:

| | First Antenna - Signal S₁ | | First Antenna - Signal S₂ | |
|---|---|---|---|---|
| | Commonly Applied | | Differentially Applied | |
| Second Antenna - | 7.5e−9 | (−81 dB) | 1.3e−8 | (−79 dB) |
| Signal S₃ | | | | |
| Commonly Applied | | | | |
| Second Antenna - | 6.0e−3 | (−22 dB) | 9.1e−4 | (−30 dB) |
| Signal S₄ | | | | |
| Differentially | | | | |
| Applied | | | | |

The values of the predicted correlation coefficients are very small. Accordingly, the RF communication system 100 can simultaneously transmit the signals, S₁, S₂, S₃, S₄ with negligible signal degradation due to interference between signals.

The RF communication system 100 also can simultaneously receive multiple signals. For example, the first hybrid 160 can forward a first inbound RF signal that is received commonly on the first and second antenna elements 112, 114 to the first transceiver 150, and forward a second inbound RF signal that is received differentially on the first and second antenna elements 112, 114 to the second transceiver 152. Similarly, the second hybrid 162 can forward a third inbound RF signal that is received commonly on the third and fourth antenna elements 122, 124 to the third transceiver 154, and forward a fourth inbound RF signal that is received differentially on the third and fourth antenna elements 122, 124 to the fourth transceiver 156. Because of the reciprocal behavior of the structure, the degree of correlation between the inbound signals received at the first, second, third and fourth transceivers 150, 152, 154, 156 also can be predicted by equation (1).

Further, in addition to MIMO operation as described above, the RF communication system 100 can operate as a diversity antenna system. For example, during a communication session, inbound RF signals can include channel status information that represents the quality of the outbound RF signals. The channel status information can include, for instance, a bit error rate and/or a packet error rate of the transmitted signals. The channel status information can be extracted from the inbound RF signals and evaluated to determine whether to implement diversity for transmitting the outbound RF signals. If, for example, the quality of the first signal S₁ being transmitted by the first antenna 110 is low, the information contained in the first signal can be forwarded to the second transceiver 152 to be transmitted in the second signal S₂. Similarly, if the quality of the second signal S₂ being transmitted by the first antenna 110 is low, the information contained in the second signal S₂ can be forwarded to the first transceiver 150 to be transmitted in the first signal S₁.

In another arrangement, if the quality of the first and second signals S₁, S₂ being transmitted by the first antenna 110 is low, the same first and second signals S₁, S₂ can be forwarded to the third and fourth transceivers 154, 156 for transmission by the second antenna 120. Likewise, if the quality of the third and fourth signals S₃, S₄ being transmitted by the second antenna 120 is low, the same third and fourth signals S₃, S₄ can be forwarded to the first and second transceivers 150, 152 for transmission by the first antenna 110.

In another arrangement, the transceivers 150, 152 can select the first signal S₁ and the second signal S₂ so that their sum is equal to zero, i.e., S₂=−S₁. In this arrangement, the antenna element 114 can be excited while the antenna element 112 is not. Likewise, the first signal S₁ and the second signal S₂ can be selected so that their difference is equal to zero, which can result in the antenna element 112 being excited while the antenna element 114 is not. In a similar manner, the transceivers 154, 156 can select the third and fourth signals S₃ and S₄ to excite either the third antenna element 122 or the fourth antenna element 124.

Furthermore, one or more of the transceivers 150, 152, 154, 156 can be selectively operable in a receive mode in which the transceiver processes signals that exhibit the highest quality reception characteristics. The reception characteristics can be determined, for example, by channel status information that includes the bit error rate and/or the packet error rate of the received signals. For example, the first transceiver 150 and/or the second transceiver 152 can be selectively operable in a receive mode in which either of the first inbound RF signal and the second inbound RF signal that exhibits higher quality signal reception characteristics in comparison to the other signal is exclusively received from the first antenna 110. Similarly, the third transceiver 154 and the fourth transceiver 156 can be selectively operable in a receive mode in which either of the third inbound RF signal and the fourth inbound RF signal that exhibits higher quality signal reception characteristics in comparison to the other signal is exclusively received from the second antenna 120.

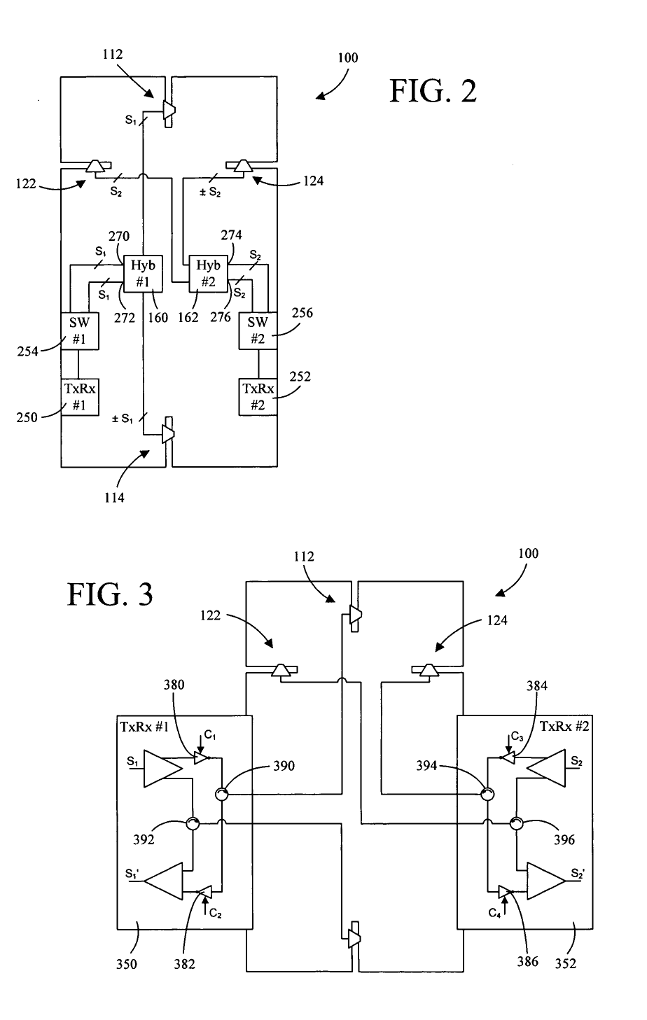

FIG. 2 depicts another arrangement of the RF communication system 100 in which the RF communication system 100 is implemented using a single pair of transceivers. For instance, the RF communication system 100 can include a first transceiver 250 and a second transceiver 252. In addition, a first switch 254 can be communicatively linked between the first transceiver 250 and the first hybrid 160, and a second switch 256 can be communicatively linked between the second transceiver 252 and the second hybrid 160. The first switch 254 and/or the first hybrid 160 can be components of the first transceiver 250, or discrete components. Similarly, the second switch 256 and/or the second hybrid 162 can be components of the second transceiver 252, or discrete components. Alternatively, the switches 254 and 256 can be replaced by respective functional blocks that combine the incoming signals according to different diversity schemes, such as Maximum Ratio Combining or Maximum Power Combining.

In a first transmit mode, the first switch 254 can receive the first signal S₁ from the first transceiver 250 and forward the first signal S₁ to a first input port 270 of the first hybrid 160, which can cause the first signal S₁ to be commonly applied to the first and second antenna elements 112, 114. In a second transmit mode, the first switch 254 can receive the first signal S₁ from the first transceiver 250 and forward the first signal S₁ to a second input port 272 of the first hybrid 160, which can cause the first signal S₁ to be differentially applied to the first and second antenna elements 112, 114.

Further, in a third transmit mode, the second switch 256 can receive the second signal S₂ from the second transceiver 252 and forward the second signal S₂ to a first input port 274 of the second hybrid 162, which can cause the second signal S₂ to be commonly applied to the third and fourth antenna elements 122, 124. In a fourth transmit mode, the second switch 256 can receive the second signal S₂ from the second transceiver 252 and forward the second signal S₂ to a second input port 276 of the second hybrid 162, which can cause the second signal S₂ to be differentially applied to the third and fourth antenna elements 122, 124.

Accordingly, the RF communication system 100 can be selectively operable in a plurality of system modes for transmitting RF signals. In a first system mode the first signal S₁ can be commonly applied to the first and second antenna elements 112, 114 while the second signal S₂ is commonly applied to the third and fourth antenna elements 122, 124. In a second system mode the first signal S₁ can be commonly applied to the first and second antenna elements 112, 114 while the second signal S₂ is differentially applied to the third and fourth antenna elements 122, 124. In a third system mode the first signal S₁ can be differentially applied to the first and second antenna elements 112, 114 while the second signal S₂ is commonly applied to the third and fourth antenna elements 122, 124. In a fourth system mode the first signal S₁ can be differentially applied to the first and second antenna elements 112, 114 while the second signal S₂ is differentially applied to the third and fourth antenna elements 122, 124.

The RF communication system 100 also can be selectively operable in a plurality of system modes for receiving RF signals. In a first of such system modes a first inbound RF signal can be commonly received from the first and second antenna elements 112, 114 while a second inbound RF signal is commonly received from the third and fourth antenna elements 122, 124. In a second system mode the first inbound RF signal can be commonly received from the first and second antenna elements 112, 114 while the second inbound RF signal is differentially received from the third and fourth antenna elements 122, 124. In a third system mode the first inbound RF signal can be differentially received from the first and second antenna elements 112, 114 while the second inbound RF signal is commonly received from the third and fourth antenna elements 122, 124. In a fourth system mode the first inbound RF signal can be differentially received from the first and second antenna elements 112, 114 while the second inbound RF signal is differentially received from the third and fourth antenna elements 122, 124. Provided all components are reciprocal, the degree of correlation between the inbound signals generated by the first and second transceivers 250, 252 also can be predicted by equation (1).

In an alternate arrangement shown in FIG. 3, in lieu of the switches and hybrids, the first transceiver 350 can include phase inverters 380, 382 and circulators 390, 392 that enable the first transceiver 350 to provide the first signal S₁ both commonly and differentially to the first and second antenna elements 112, 114, and to receive signals both commonly and differentially from the first and second antenna elements 112, 114. Similarly, the second transceiver 352 can include phase inverters 384, 386 and circulators 394, 396 that enable the second transceiver 352 to provide the second signal S₂ both commonly and differentially to the third and fourth antenna elements 122, 124, and to receive signals both commonly and differentially from the third and fourth antenna elements 122, 124. In an alternate arrangement, duplexers can be used in the respective transceivers 350, 352 in lieu of the circulators 390, 392, 394, 396. The duplexers can separate the frequency bands on which the transceivers 350, 352 transmit and receive, which can virtually eliminate the amount of transmitted energy that is reflected back to a particular transceiver 350, 352 when that transceiver 350, 352 simultaneously transmits and receives.

In operation, a first control signal C₁ and a second control signal C₂ can selectively turn on and turn off the phase inverters 380, 382, thereby controlling signal flow of signals to and from the first antenna element 112. For instance, to provide the first signal S₁ commonly to the first and second antenna elements 112, 114, the phase inverter 380 can be turned off thereby providing the first signal S₁ to the first antenna element 112 with a 0° phase shift. In this arrangement, the first signal S₁ also can be provided to the second antenna element 114 with a 0° phase shift. In order to provide the first signal S₁ differentially to the first and second antenna elements 112, 114, the phase inverter 380 can be turned on, thereby providing the first signal S₁ to the first antenna element 112 with a 180° phase shift. The phase inverters 384, 386 and circulators 394, 396 can be operatively controlled by a third control signal C₃ and a fourth control signal C₄ in a similar manner to apply the second signal S₂ both commonly and differentially to the third and fourth antenna elements 122, 124, and to receive the signals both commonly and differentially from the third and fourth antenna elements 122, 124.

In this arrangement, each transceiver 350, 352 can simultaneously transmit and receive signals using different antenna modes. For instance, the transceiver 350 can transmit a signal by commonly applying the signal to antenna elements 112, 114 while simultaneously receiving a signal differentially from the antenna elements 112, 114. Accordingly, the transceivers 350, 352 each can select an optimum transmit mode independent of an optimum receive mode that is selected.

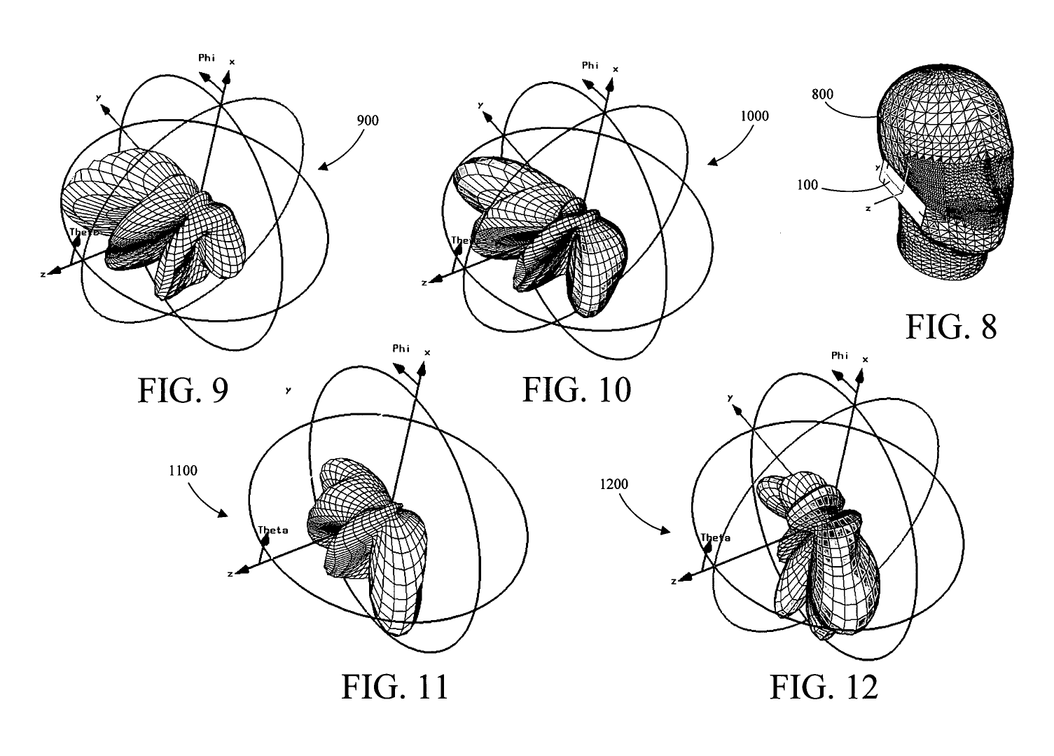

Referring to FIG. 8, the RF communication system 100 can be operated next to a human head 800, for example when used in a conventional mobile telephone. An example of the field pattern 900 that can be produced by common excitation of the first and second antenna elements 112, 114 during such operation is shown in FIG. 9. An example of the field pattern 1000 that can be produced by differential excitation of the first and second antenna elements 112, 114 when operated in accordance with FIG. 8 is shown in FIG. 10. An example of the field pattern 1100 that can be produced by common excitation of the third and fourth antenna elements 122, 124 corresponding to such operation is shown in FIG. 11. An example of the field pattern 1200 that can be produced by differential excitation of the third and fourth antenna elements 122, 124 while the RF communication system 100 is operated next to the human head is shown in FIG. 12.

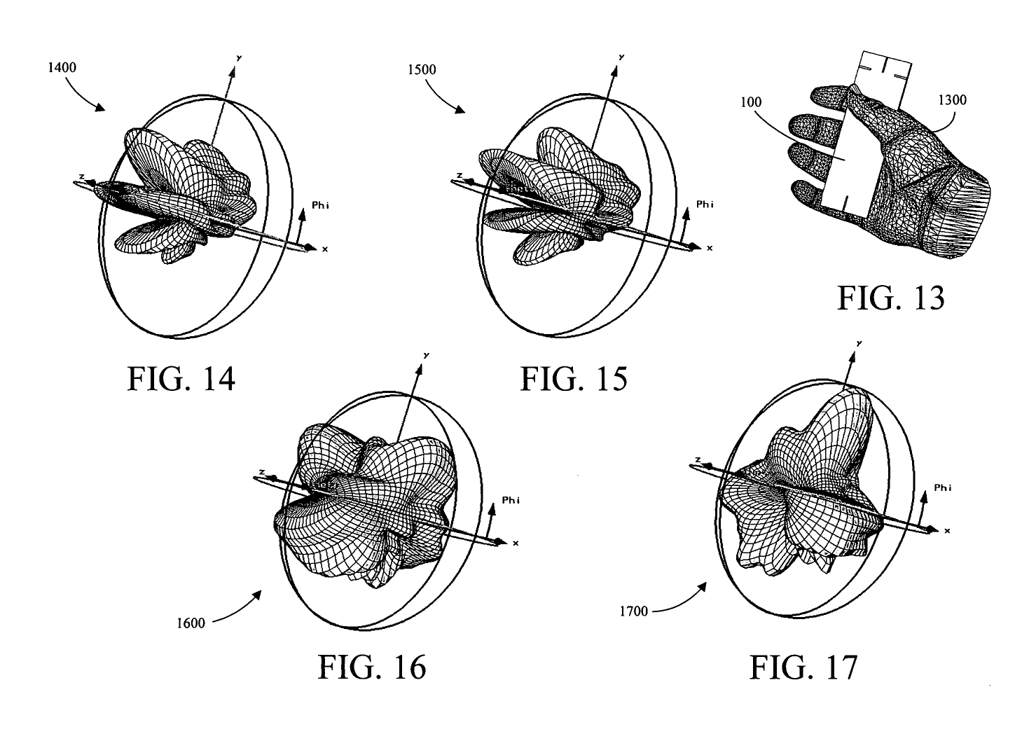

Referring to FIG. 13, the RF communication system 100 also can be operated while being held in a hand 1300, for instance when used with a Bluetooth headset. An example of the field pattern 1400 that can be produced by common excitation of the first and second antenna elements 112, 114 during such operation is shown in FIG. 14. An example of the field pattern 1500 that can be produced by differential excitation of the first and second antenna elements 112, 114 when operated in accordance with FIG. 13 is shown in FIG. 15. An example of the field pattern 1600 that can be produced by common excitation of the third and fourth antenna elements 122, 124 corresponding to such operation is shown in FIG. 16. Finally, an example of the field pattern 1700 that can be produced by differential excitation of the third and fourth antenna elements 122, 124 while the RF communication system 100 is operated while held in a human hand is shown in FIG. 17.

As used herein, numerical references such as “first,” “second,” “third,” “fourth,” etc. distinguish specific structures or steps from other structures or steps. Such numerical references do not, however, indicate any specific structural order or an order of steps performed in any process. The term “commonly applied,” as used herein, is defined as applying signals in-phase. Similarly, the term “commonly receive,” as used herein, is defined as receiving signals either with no applied phase adjustments, or with similar phase adjustments applied to each of the subject signals. The term “differentially applied,” as used herein, is defined as applying signals out-of-phase (e.g. with a phase difference of approximately 180°). The term “differentially receive,” as used herein, is defined as receiving signals out-of-phase.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. communicatively linked through a communication channel or pathway. The term “proximate to,” as used herein, is defined as at or near. For example, an antenna element proximate to an end portion of a printed circuit board can be at, or near, the end portion.

This invention can be embodied in other forms without departing from the spirit or essential attributes thereof. Accordingly, reference should be made to the following claims, rather than to the foregoing specification, as indicating the scope of the invention.

What is claimed is:

1. An RF communication system comprising:
a first antenna comprising a first antenna element and at least a second antenna element;
a second antenna comprising a third antenna element and at least a fourth antenna element;
a first transmitter that applies a first outbound RF signal commonly to the first and second antenna elements;
a second transmitter that applies a second outbound RF signal differentially to the first and second antenna elements;
a third transmitter that applies a third outbound RF signal commonly to the third and fourth antenna elements; and
a fourth transmitter that applies a fourth outbound RF signal differentially to the third and fourth antenna elements.

2. The RF communication system of claim 1, further comprising a printed circuit board, the printed circuit board comprising a first edge portion and a second edge portion opposingly positioned with respect to the first edge portion, wherein the first antenna element is disposed proximate to the first edge portion and the second antenna element is disposed proximate to the second edge portion.

3. The RF communication system of claim 2, wherein the printed circuit board further comprises a third edge portion and a fourth edge portion opposingly positioned with respect to the third edge portion, wherein the third antenna element is disposed proximate to the third edge portion and the fourth antenna element is disposed proximate to the fourth edge portion.

4. The RF communication system of claim 3, wherein an orientation of the first antenna is perpendicular to an orientation of the second antenna.

5. The RF communication system of claim 1, wherein the first transmitter and the second transmitter are selectively operable in a transmit mode in which a signal, which is selected from a first group consisting of the first outbound RF signal and the second outbound RF signal, that exhibits higher quality signal transmission characteristics in comparison to the other signal in the first group is exclusively transmitted from the first antenna.

6. The RF communication system of claim 5, wherein the third transmitter and the fourth transmitter are selectively operable in a transmit mode in which a signal, which is selected from a second group consisting of the third outbound RF signal and the fourth outbound RF signal, that exhibits higher quality signal transmission characteristics in comparison to the other signal in the second group is exclusively transmitted from the second antenna.

7. The RF communication system of claim 1, further comprising:
a first receiver that receives a first inbound RF signal commonly from the first and second antenna elements;
a second receiver that receives a second inbound RF signal differentially from the first and second antenna elements;
a third receiver that receives a third inbound RF signal commonly from the third and fourth antenna elements; and
a fourth receiver that receives a fourth inbound RF signal differentially from the third and fourth antenna elements.

8. The RF communication system of claim 7, wherein the first receiver and the second receiver are selectively operable in a receive mode in which a signal, which is selected from a first group consisting of the first inbound RF signal and the second inbound RF signal, that exhibits higher quality signal reception characteristics in comparison to the other signal in the first group is exclusively received from the first antenna.

9. The RF communication system of claim 7, wherein the third receiver and the fourth receiver are selectively operable in a receive mode in which a signal, which is selected from a second group consisting of the third inbound RF signal and the fourth inbound RF signal, that exhibits higher quality signal reception characteristics in comparison to the other signal in the second group is exclusively received from the second antenna.

10. An RF communication system comprising:
a first antenna comprising a first antenna element and at least a second antenna element;
a second antenna comprising a third antenna element and at least a fourth antenna element;
a first transmitter that applies a first outbound RF signal commonly to the first and second antenna elements in a first transmit mode and applies the first outbound RF signal differentially to the first and second antenna elements in a second transmit mode; and
a second transmitter that applies a second outbound RF signal commonly to the third and fourth antenna elements in a third transmit mode, and applies the second outbound RF signal differentially to the third and fourth antenna elements in a fourth transmit mode.

11. The RF communication system of claim 10, wherein the RF communication system is selectively operable in a plurality of system modes comprising:
a first system mode in which the first transmitter operates in the first transmit mode and the second transmitter operates in the third transmit mode;
a second system mode in which the first transmitter operates in the first transmit mode and the second transmitter operates in the fourth transmit mode;
a third system mode in which the first transmitter operates in the second transmit mode and the second transmitter operates in the third transmit mode; and
a fourth system mode in which the first transmitter operates in the second transmit mode and the second transmitter operates in the fourth transmit mode.

12. The RF communication system of claim 10, further comprising a printed circuit board, the printed circuit board comprising a first edge portion and a second edge portion opposingly positioned with respect to the first edge portion, wherein the first antenna element is disposed proximate to the first edge portion and the second antenna element is disposed proximate to the second edge portion.

13. The RF communication system of claim 12, wherein the printed circuit board further comprises a third edge portion and a fourth edge portion opposingly positioned with respect to the third edge portion, wherein the third antenna element is disposed proximate to the third edge portion and the fourth antenna element is disposed proximate to the fourth edge portion.

14. The RF communication system of claim 13, wherein an orientation of the first antenna is perpendicular to an orientation of the second antenna.

15. The RF communication system of claim 10, wherein the first transmitter is selectively operable in the first transmit mode if the first outbound RF signal exhibits higher quality signal transmission characteristics in the first transmit mode in comparison to the second transmit mode, and the first transmitter is selectively operable in the second transmit mode if the first outbound RF signal exhibits higher quality signal transmission characteristics in the second transmit mode in comparison to the first transmit mode.

16. The RF communication system of claim 15, wherein the second transmitter is selectively operable in the third transmit mode if the second outbound RF signal exhibits higher quality signal transmission characteristics in the third transmit mode in comparison to the fourth transmit mode, and the second transmitter is selectively operable in the fourth transmit mode if the second outbound RF signal exhibits higher quality signal transmission characteristics in the fourth transmit mode in comparison to the third transmit mode.

17. The RF communication system of claim 10, further comprising:
a first receiver that receives a first inbound RF signal commonly from the first and second antenna elements in a first receive mode, and receives the first inbound RF signal differentially from the first and second antenna elements in a second receive mode; and
a second receiver that receives a second inbound RF signal commonly from the third and fourth antenna elements in a third receive mode, and receives the second inbound RF signal differentially from the third and fourth antenna elements in a fourth receive mode.

18. The RF communication system of claim 17, wherein the RF communication system is selectively operable in a plurality of system modes comprising:
a first system mode in which the first receiver operates in the first receive mode and the second receiver operates in the third receive mode;
a second system mode in which the first receiver operates in the first receive mode and the second receiver operates in the fourth receive mode;
a third system mode in which the first receiver operates in the second receive mode and the second receiver operates in the third receive mode; and
a fourth system mode in which the first receiver operates in the second receive mode and the second receiver operates in the fourth receive mode.

19. The RF communication system of claim 17, wherein the first receiver is selectively operable in the first receive mode if the first inbound RF signal exhibits higher quality signal receive characteristics in the first receive mode in comparison to the second receive mode, and the first receiver is selectively operable in the second receive mode if the first inbound RF signal exhibits higher quality signal receive characteristics in the second receive mode in comparison to the first receive mode.

20. The RF communication system of claim 17, wherein the second receiver is selectively operable in the third receive mode if the second inbound RF signal exhibits higher quality signal receive characteristics in the third receive mode in comparison to the fourth receive mode, and the second receiver is selectively operable in the fourth receive mode if the second inbound RF signal exhibits higher quality signal receive characteristics in the fourth receive mode in comparison to the third receive mode.
